(19) United States
(12) Patent Application Publication
(10) Pub. No.: US 2025/0377015 A1
(43) Pub. Date: Dec. 11, 2025

(54) SUSPENSION BEARING UNIT WITH A GASKET

(71) Applicant: AKTIEBOLAGET SKF, GOTEBORG (SE)

(72) Inventors: Paul RABOURDIN, Chambray lès Tours (FR); Romain MEDARIAN, Tours (FR); Jordan RENAUDON, Saint-Cyr-Sur-Loire (FR); Xavier BLANCHARD, Saint-Cyr-Sur-Loire (FR)

(21) Appl. No.: 19/227,756

(22) Filed: Jun. 4, 2025

(30) Foreign Application Priority Data
Jun. 11, 2024 (FR) 2406136

(51) Int. Cl. F16C 19/16; F16C 33/76; F16C 43/04

(52) U.S. Cl. CPC F16C 19/163; F16C 33/76; F16C 43/045; F16C 2326/05

(57) ABSTRACT

A suspension bearing unit includes a lower support cap, an upper bearing cap and at least one bearing arranged between the caps. The lower support cap includes an annular radial portion that is at least partially recessed so as to leave a plurality of ribs spaced apart from one another in the circumferential direction. The unit includes a gasket that is provided with a heel overmolded on the recessed part of the recessed annular radial portion and on the ribs, and which is provided with a sealing portion supported by the heel and extending towards the upper bearing cap (4). The distal end of the sealing portion of the gasket forms a dynamic annular seal with the upper bearing cap.

### CROSS-REFERENCE

This application claims priority to French patent application no. 2406136 filed on Jun. 11, 2024, the contents of which are fully incorporated herein by reference.

### BACKGROUND OF THE INVENTION

The present invention relates to bearings, and more particularly to suspension bearing units used for motor vehicles in the suspension struts of the steered wheels.

A suspension bearing unit generally comprises a bearing that forms an axial thrust bearing and upper and lower caps that form a housing for the rings of the bearing and that provide the interface between the rings and neighboring elements.

The suspension bearing unit is arranged in the upper part of the suspension strut between a suspension spring and the vehicle body. The suspension spring is mounted around a shock-absorber piston rod, the end of which is connected to the vehicle body. A helical suspension spring is axially supported directly or indirectly on the lower cap of the suspension bearing unit.

The suspension bearing unit allows axial and radial forces to be transmitted between the suspension spring and the vehicle body while allowing a relative rotational movement between the lower cap and the upper cap as a result of the steered wheels of the vehicle being turned and/or the suspension spring being compressed.

Generally, the upper cap of the suspension bearing unit is provided with a plurality of hooks arranged on an outer skirt and designed to diametrically engage with a plurality of hooks on the lower cap. The hooks of each cap are spaced apart from one another in the circumferential direction.

These hooks form a retaining means for axially retaining the upper and lower caps in relation to one another. The hooks also form narrow passages in order to limit the intrusion of contaminating particles radially between the outer skirt of the upper cap and the lower cap.

However, such a suspension bearing unit is generally exposed to various types of contamination.

Specifically, the contaminating particles may infiltrate between the outer skirt of the upper cap and the lower cap, and then be directed toward the bearing and introduced into the latter.

To overcome this drawback, solutions have been proposed, such as disclosed in German patent publication no. DE 102020201404 A1, which teaches providing an external gasket that is fixed by clamping between the bearing and the lower cap of the suspension bearing unit and is provided with at least one sealing lip that interacts with the upper cap.

### SUMMARY OF THE INVENTION

The aim of the present invention is to simplify the manufacture of this type of suspension bearing unit.

As such, the present invention is directed to a suspension bearing unit comprising a lower support cap, an upper bearing cap and at least one bearing arranged between the caps.

The lower support cap comprises an annular radial portion that is at least partially recessed so as to leave a plurality of ribs spaced apart from one another in the circumferential direction.

The suspension bearing unit also comprises a gasket that is provided with a heel overmolded on the recessed part of the recessed annular radial portion and on the ribs, and which is provided with a sealing portion supported by the heel and extending toward the upper bearing cap.

The distal end of the sealing portion of the gasket forms a dynamic annular seal with the upper bearing cap.

The annular radial portion of the lower support cap leaving the plurality of ribs improves the grip of the heel of the gasket on the lower support cap and facilitates overmolding of the gasket.

Overmolding the gasket makes it possible to eliminate an operation when assembling the bearing unit. In addition, this also makes it possible to eliminate a packaging element for the gasket, which is conventionally provided in bearing units comprising a gasket that is separated and then assembled on one of the caps.

In addition, providing ribs makes it possible to further improve the connection between the overmolded gasket and the lower support cap, particularly in the circumferential direction.

The distal end of the sealing portion of the gasket forming a dynamic annular seal with the upper bearing cap forms a barrier stopping contaminating particles travelling or migrating toward the bearing.

Preferably, the gasket is annular.

Preferably, the gasket is in one piece.

In a first embodiment, the sealing portion of the gasket forms a seal by frictional contact with the upper bearing cap.

In an alternative second embodiment, the sealing portion of the gasket forms a seal with the upper bearing cap via one or more narrow passages.

In an alternative third embodiment, the sealing portion of the gasket may form both a seal with the upper bearing cap via one or more narrow passages and a seal by frictional contact with the upper bearing cap.

Advantageously, the sealing portion comprises an intermediate portion extending at least axially towards the upper bearing cap from the heel of the gasket and a distal portion extending at least radially inward from the intermediate portion of the sealing portion.

Optionally, the intermediate portion of the sealing portion extends radially outwardly and axially toward the upper bearing cap.

Optionally, the distal portion of the sealing portion extends radially inwardly and axially toward the upper bearing cap.

This means that the sealing portion of the gasket is axially flexible.

According to a particular design, the intermediate portion of the sealing portion extends from a radially inner edge of the heel of the gasket, remaining at a distance from a radially outer edge of the heel of the gasket.

This means that the flexibility of the sealing portion of the gasket is improved.

Advantageously, the recessed annular radial portion forms a groove, each rib extending from the bottom of the groove.

Optionally, each rib remains at a distance from a radially inner edge of the recessed annular radial portion.

According to a particular design, the lower support cap comprises an annular radial portion and a shoulder that extends from the radial portion towards the upper bearing cap and is provided with the recessed annular radial portion.

Optionally, the recessed annular radial portion remains at a distance from a large-diameter edge of the shoulder of the lower support cap.

According to a particular design, the upper bearing cap comprises an annular outer skirt that radially surrounds the gasket. The annular outer skirt of the upper bearing cap protects the gasket during handling of the suspension bearing unit, in particular from shocks during the transport and handling thereof.

Advantageously, the sealing portion remains at a distance from the annular outer skirt of the upper bearing cap.

Alternatively, the sealing portion may be radially in contact with an internal surface of the annular outer skirt of the upper bearing cap.

Advantageously, the distal end of the sealing portion is axially in contact with the upper bearing cap, in particular a radial portion of the upper bearing cap.

Optionally, at least one cavity is formed on the sealing portion and is open towards the upper bearing cap, the cavity being filled with lubricant. The lubricant-filled cavity of the sealing portion improves the seal between the sealing portion of the gasket and the upper bearing cap by forming a barrier that stops contaminating particles travelling toward the bearing. In addition, the lubricant reduces friction between the sealing portion of the gasket and the upper bearing cap, reducing wear on the gasket and the friction torque of the bearing unit.

### BRIEF DESCRIPTION OF THE SEVERAL VIEWS OF THE DRAWINGS

The present invention will be better understood on studying the detailed description of embodiments, given by way of non-limiting example and illustrated by the appended drawings, in which:

FIG. 1 is an axial cross-sectional view of a suspension bearing unit according to an exemplary embodiment of the invention;

FIG. 2 and FIG. 3 are each a detail view of the unit of FIG. 1; and

FIG. 4 is a perspective view of part of a gasket of the bearing unit in FIG. 1.

### DETAILED DESCRIPTION OF THE INVENTION

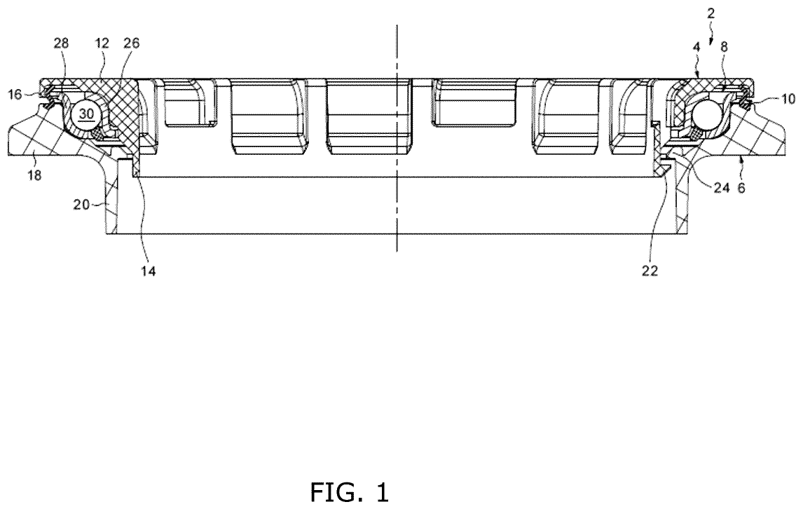

The suspension bearing unit 2 shown in FIG. 1 is designed to be installed between a cup or upper bearing seat coming into contact with a fixed chassis element of a motor vehicle, and a helical suspension spring. In FIG. 1, the unit 2 is shown in an assumed vertical position.

The unit 2 has an axis X-X′ and comprises an upper bearing cap 4, a lower support cap 6, and a rolling bearing 8 interposed axially between the upper bearing cap 4 and the lower support cap 6.

In the example illustrated, the upper bearing cap 4 and lower support cap 6 are mounted in direct contact with the bearing 8 without an interposed intermediate element. In a variant, the upper bearing cap 4 and lower support cap 6 may be mounted in indirect contact with the bearing 8 with an interposed intermediate element.

As will be described in more detail below, the unit 2 also comprises an external annular gasket 10 for preventing the intrusion of contaminants toward the bearing 8, the gasket 10 being overmolded on the lower support cap 6 and extending toward the upper bearing cap 4.

The gasket 10 is, for example, made from an elastically deformable material, for example from nitrile or from an elastomer. The gasket 10 may also be made of a stiffer material, for example polyoxymethylene (POM) or even steel.

The upper bearing cap 4 consists of a single piece, for example made of a plastic material, such as polyamide PA 6.6, for example, which may or may not be reinforced with glass fibers.

The upper bearing cap 4, with axis X-X′, includes a radial portion 12, an annular axial inner skirt 14, and an annular axial outer skirt 16 radially surrounding the inner skirt 14.

The radial portion 12 of the upper bearing cap 4 has an upper surface (not indicated) intended to face the upper bearing seat and an opposite lower surface (not indicated) in contact with the bearing 8. The upper and lower surfaces define the thickness of the radial portion 12 of the upper bearing cap 4.

The outer skirt 16 of the upper bearing cap 4 extends axially from the radial portion 12 of the upper bearing cap 4. In the example illustrated, the outer skirt 16 of the upper bearing cap 4 continues or extends from a large-diameter edge of the radial portion 12 of the upper bearing cap 4. In particular, the outer skirt 16 radially surrounds the gasket 10.

The inner skirt 14 of the upper bearing cap 4 extends inside the bore of the lower support cap 6. The inner and outer skirts 14, 16 of the upper bearing cap 4 extend axially downwardly from the radial portion 12 of the upper bearing cap 4. The inner skirt 14 continues or extends from a small-diameter edge of the radial portion 12 of the upper bearing cap 4. The outer skirt 16 continues/extends from a large-diameter edge of the radial portion 12 of the upper bearing cap 4.

The lower support cap 6 preferably consists of a single-piece body, for example made of a plastic material, such as for example polyamide PA 6.6, which may or may not be reinforced with glass fibers.

The lower support cap 6, with axis X-X′, includes an annular radial portion 18 in the form of a plate, and an annular axial skirt 20 continuing or extending from a small-diameter edge of the radial portion 18 of the lower support cap 6.

The axial skirt 20 of the lower support cap 6 extends axially downwardly away from the upper bearing cap 4 and the bearing 8. The axial skirt 20 of the lower support cap 6 enables centering of the suspension spring.

The radial portion 18 of the lower support cap 6 has a lower annular radial surface (not indicated) which delimits a bearing surface for the suspension spring.

The upper bearing cap 4 includes a plurality of internal hooks 22 arranged on the inner skirt 14 of the upper bearing cap 4 and extending radially outwardly in the direction of the lower support cap 6. In the example illustrated, the hooks 22 are spaced apart from one another in the circumferential direction. Alternatively, a single annular hook 22 may be provided.

The lower support cap 6 includes a plurality of internal hooks 24 arranged on the radial portion 18 of the lower support cap 6 and extending radially inwardly in the direction of the upper bearing cap 4, the plurality of internal hooks 24 being designed to diametrically engage with the plurality of internal hooks 22 of the upper bearing cap 4. Alternatively, a single annular hook 24 may be provided.

The hooks 22, 24 form a retaining means for axially retaining the upper bearing cap 4 and lower support cap 6 in relation to each other.

The bearing 8 is located radially between the inner and outer skirts 14, 16 of the upper bearing cap 4. The bearing 8 includes an upper ring 26 in contact with the upper bearing cap 4, a lower ring 28 in contact with the lower support cap 6 and a row of rolling elements 30, in this case balls, arranged between the raceways formed on the rings 26, 28. In the example illustrated, the rolling bearing 8 is an angular contact bearing. The upper ring 26 is in contact with the lower surface of the radial portion 12 of the upper bearing cap 4, the lower surface having a complementary shape to the upper ring 26 of the bearing 8. The lower ring 28 is in contact with an upper surface of the lower support cap 6, the upper surface having a complementary shape to the lower ring 28 of the bearing 8.

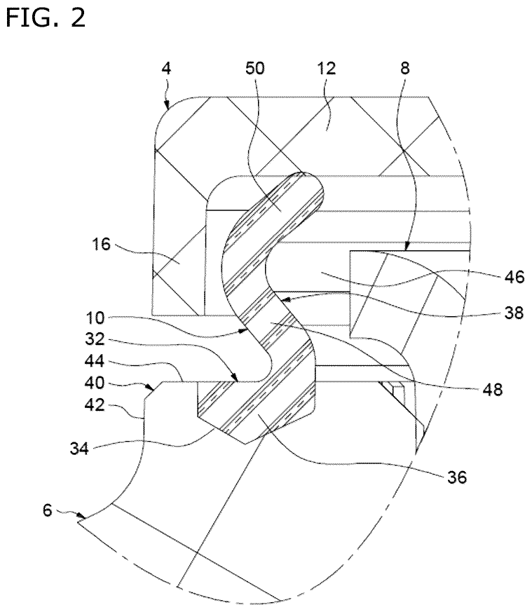

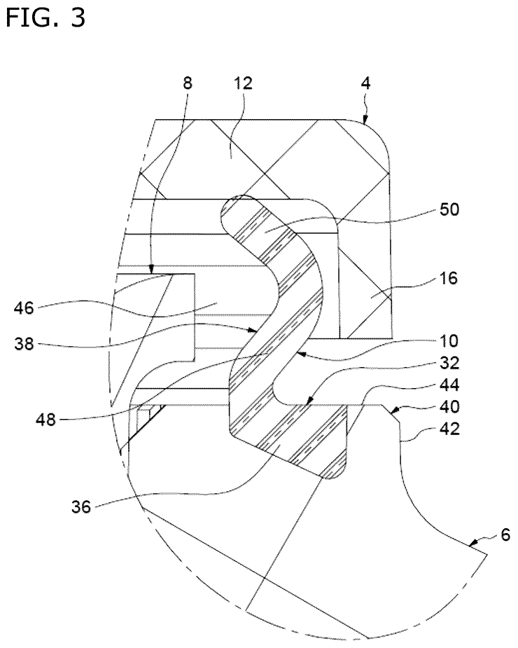

As illustrated more clearly in FIGS. 2 and 3, the lower support cap 6 includes an annular radial portion 32 that is recessed so as to leave a plurality of ribs 34 spaced apart from each other in the circumferential direction. More specifically, the recessed annular radial portion 32 forms a groove and each rib 34 extends from the bottom of the groove. The ribs 34 are regularly or evenly spaced in the circumferential direction. In a variant, it is possible to provide ribs 34 that are irregularly spaced or “staggered” in the circumferential direction.

The gasket 10 is provided with a heel 36 overmolded on the recessed part of the recessed annular radial portion 32 and on the ribs 34, and with a sealing portion 38 supported by the heel 36 and extending toward the upper bearing cap 4. The gasket 10 is annular and mounted radially around the bearing 8.

The distal end of the sealing portion 38 of the gasket 10 forms a dynamic annular seal with the upper bearing cap 4, the distal end of the sealing portion 38 preferably being axially in contact with the upper bearing cap 4, and more specifically with a lower surface of the radial portion 12 of the upper bearing cap 4. The distal end of the sealing portion 38 is preferably offset radially outwardly with respect to the bearing 8.

In addition, the lower support cap 6 includes a shoulder 40 in the axial extension of the outer skirt 16 of the upper bearing cap 4 and in which the recessed annular radial portion 32 is formed. In other words, the outer skirt 16 of the upper bearing cap 4 is located axially above the shoulder 40.

The shoulder 40 of the lower support cap 6 is formed by a first surface 42 of the lower support cap 6 that is concave and by a second surface 44 of the lower support cap 6 that extends entirely radially. The first surface 42 of the lower support cap 6 extends from a large-diameter edge of the second surface 44 of the lower support cap 6.

In a variant, the first surface 42 of the shoulder 40 may be flat and extends entirely axially, or both axially and radially, i.e. obliquely. In a variant, the second surface 44 of the shoulder 40 may extend both radially outwardly and axially downwardly.

Preferably, the recessed annular radial portion 32 remains at a distance from, i.e. is spaced a distance from, a large-diameter edge of the shoulder 40 of the lower support cap 6 and in particular from the first surface 42 of the shoulder 40.

Each rib 34 extends from the bottom of the recessed annular radial portion 32, remaining radially at a distance from, or spaced a distance from, a radially inner edge of the recessed annular radial portion 32 and is spaced axially a distance from the second surface 44 of the shoulder 40.

The sealing portion 38 of the gasket 10 extends into an annular space 46 defined radially between the outer skirt 16 of the upper bearing cap 4 and the bearing 8 and axially between the radial portion 12 of the upper bearing cap 4 and the second surface 44 of the shoulder 40. Preferably, the sealing portion 38 of the gasket 10 is spaced a distance from the annular outer skirt 16 of the upper bearing cap 4, which improves the flexibility of the sealing portion 38 of the gasket 10.

The cross section of the gasket 10 is S-shaped. In particular, the sealing portion 38 of the gasket 10 includes an intermediate portion 48 extending radially outwardly and axially toward the upper bearing cap 4 from the heel 36 of the gasket 10 and a distal portion 50 extending radially inwardly and axially toward the upper bearing cap 4 from the intermediate portion 48 of the sealing portion 38.

More specifically, the intermediate portion 48 of the sealing portion 38 extends from a radially inner edge of the heel 36 of the gasket 10 and is spaced a distance apart from a radially outer edge of the heel 36 of the gasket 10.

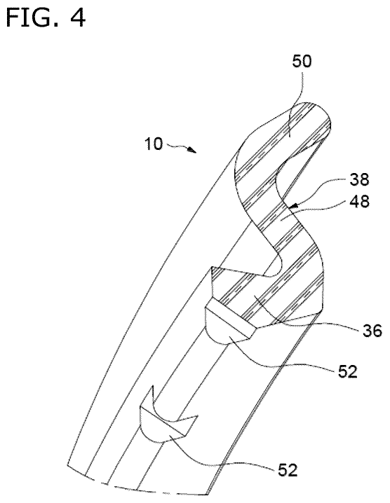

As illustrated in FIG. 4, a plurality of notches 52 are formed in the heel 36 of the gasket 10 by each of the ribs.

In the exemplary embodiments illustrated, the bearing unit 2 comprises a single external gasket 10 located radially between the lower support cap 6 and the outer skirt 16 of the upper bearing cap 4. In combination, the unit 2 may further comprise an internal gasket located radially between the lower support cap 6 and the inner skirt 14 of the upper bearing cap 4.

In the exemplary embodiments illustrated, the bearing unit 2 comprises a single external gasket 10 provided with a single sealing portion. Alternatively, the unit 2 may comprise a plurality of external gaskets or a single gasket provided with a plurality of sealing portions.

In the exemplary embodiments illustrated, the bearing unit 2 comprises an angular contact rolling bearing 8 provided with a row of balls. However, the unit 2 may comprise other types of rolling bearings, for example a bearing with four points of contact and/or with at least two rows of balls. The rolling bearing may comprise other types of rolling elements 30, for example cylindrical rollers, tapered rollers, needles, etc. In another variant, the bearing 8 of the unit 2 may comprise a sliding or journal bearing without any rolling elements and provided with one or more rings.

Representative, non-limiting examples of the present invention were described above in detail with reference to the attached drawings. This detailed description is merely intended to teach a person of skill in the art further details for practicing preferred aspects of the present teachings and is not intended to limit the scope of the invention.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter. The invention is not restricted to the above-described embodiments, and may be varied within the scope of the following claims.

We claim:

1. A suspension bearing unit comprising:
a lower support cap including an annular radial portion at least partially recessed so as to define a plurality of ribs spaced apart from each other in the circumferential direction;
an upper bearing cap;
at least one bearing arranged between the lower support cap and the upper bearing cap; and
a gasket including a heel, the heel being overmolded on the recessed part of the annular radial portion and on the ribs of the lower support cap, and a sealing portion supported by the heel and extending toward the upper bearing cap, the sealing portion having a distal end forming a dynamic annular seal with the upper bearing cap.

2. The suspension bearing unit according to claim 1, wherein the sealing portion of the gasket includes an intermediate portion extending at least axially toward the upper bearing cap from the heel of the gasket and a distal portion extending at least radially inwardly from the intermediate portion.

3. The suspension bearing unit according to claim 2, wherein the intermediate portion of the sealing portion extends radially outwardly and axially toward the upper bearing cap, the distal portion of the sealing portion extending radially inwardly and axially toward the upper bearing cap.

4. The suspension bearing unit according to claim 2, wherein the intermediate portion of the sealing portion extends from a radially inner edge of the heel of the gasket and is spaced a distance apart from a radially outer edge of the heel of the gasket.

5. The suspension bearing unit according to claim 1, wherein the recessed annular radial portion forms a groove with a bottom, each rib extending from the bottom of the groove.

6. The suspension bearing unit according to claim 1, wherein each rib is spaced a distance apart from a radially inner edge of the recessed annular radial portion.

7. The suspension bearing unit according to claim 1, wherein the lower support cap includes an annular radial portion and a shoulder extending from the radial portion toward the upper bearing cap and providing the annular recessed radial portion of the lower support cap.

8. The suspension bearing unit according to claim 7, wherein the recessed annular radial portion is spaced a distance apart from a large-diameter edge of the shoulder of the lower support cap.

9. The suspension bearing unit according to claim 1, wherein the sealing portion of the gasket is spaced a distance apart from an annular outer skirt of the upper bearing cap.

10. The suspension bearing unit according to claim 1, wherein the distal end of the sealing portion of the gasket axially contacts the upper bearing cap.
